(19) United States
(12) Patent Application Publication
(10) Pub. No.: US 2008/0290628 A1
(43) Pub. Date: Nov. 27, 2008

(54) Panther Front And Rear Wheel Drive Bicycle

(76) Inventor: John Tulpan, Kent, OH (US)

Correspondence Address: JOHN TULPAN, 6322 Breton Lakes Drive, Willowbrook, IL, 60527-5387, US

(21) Appl. No.: 11/753,446

(22) Filed: May 24, 2007

(51) Int. Cl. B62M 1/12; B62M 3/00

(52) U.S. Cl. 280/249; 280/234

(57) ABSTRACT

The regular handlebar and front wheel of a bicycle are replaced by a steering head including a pair of hand cranks, and by a sprockets-containing front wheel. The hand cranks are positioned such that the rider's weight center is stabilized unto the cycle's seat, away from his hands. A sprocket mounted unto the hand cranks' drive shaft transmits the power from the hand cranks, through a continuous chain, to the front wheel's sprockets. A set of brake cables and bearings prevent the brakes' cables from twisting, while rotating the hand cranks. The regular cycle's seat is replaced by a back support-containing seat. The rider can position the hand cranks in unison or alternatively. The rider can drive the bicycle by simultaneous or independent foot and hand operation. The addition of a set of hand cranks to a regular bicycle enables an increase in the cycle's speed, along with intensified exercise. The hand cranks system can be mounted and unmounted onto any existing bicycle. The hand cranks mechanism exhibits great simplicity, while maintaining safety and very good steering ease.

### REFERENCES CITED

### U.S. PATENT DOCUMENTS

U.S. Pat. No. 484,712 October 1892 Hartley—280/234
U.S. Pat. No. 632,797 September 1899 Van Horn—280/234
U.S. Pat. No. 3,485,508 December 1969 Hudnall—280/234
U.S. Pat. No. 4,773,662 September 1988 Phillips—280/234
U.S. Pat. No. 4,858,942 July. 1989 Rodriguez—280/233
U.S. Pat. No. 5,082,302 January 1992 Nacar—280/234
U.S. Pat. No. 5,385,359 January 1995 Ehrbar—280/234
U.S. Pat. No. 5,816,598 October 1998 Dodakian—280/234
U.S. Pat. No. 5,908,199 June 1999 Rigato—280/233

### BACKGROUND OF THE INVENTION

This invention relates generally to bicycles, and more particularly to bicycles that can be propelled by feet and hands together. It also relates to stationary gym exercise cycles.

Bicycles are very popular nowadays for transportation, or for physical fitness and enjoyment. Yet, the majority of bike riders use only their feet for propulsion. A cyclist using both hands and feet for motive power could improve both speed and physical fitness.

The concept of a bicycle propelled by both hands and feet is not new. Many attempts have been made, by different inventors, in an effort to develop such a bicycle, while maintaining ease and safety of steering. One system that allows the rider to use his hands along with his feet while riding a bicycle is the push-pull mechanism; another system is the rotary system, and this is the system the present invention is based upon. Such a system will generally include a drive sprocket mounted on the steering head, which, through mechanisms varying from one patent to another, is connected to a driven sprocket, mounted on one of the wheels. The crank-shaft and the cranks will normally be mounted on the steering head, at the top of the front journal. One example of such a bicycle is disclosed in U.S. Pat. No. 484,712 to Hartley. The Hartley bicycle is a dual hand/foot powered bicycle, which differs from normal bicycles in that cranking the handlebars will drive a chain, which in turn drives the front wheel. This bicycle's cranks are too short, though, to allow significant movement of the arms, and hence the cranks' contribution to the overall power of the bicycle is rather minimal.

There are many other patents using rotary systems, and since I will try to compare and relate one patent to another, henceforth I will refer to them by installed mechanisms and function, rather than by their issue dates.

One example of a bicycle that allows the rider to use his hands through a rotary system is disclosed in U.S. Pat. No. 4,858,942 by Rodriguez. In the Rodriguez bicycle, the upper frame member is inclined downward and to the left in order to provide clearance between the hand cranks mechanism and the cross member when the front fork is turned to the right. Which means that this model can not be simply installed on existing bicycles, but rather that entire custom-framed bicycles would be needed; or, at its best, the regular front section of a cycle needs to be cut off, and a new frame, including the proposed front section, needs to be welded into place. This is a potential disadvantage, as buyers have to purchase a whole new bicycle—while in the case they modify their existing bicycles, and they decide to switch back to the old, standard bicycle settings, cutting and welding would be needed again. However, not these are the biggest inconveniences with Rodriguez's model: the main disadvantages of this bicycle are that it is almost impossible to steer while propelling it by hand, and that it is very hard on the rider's abdominal muscles, due to the low position of the cranks system relative to the cyclist's body. Rodriguez argues in his patent that putting the cyclist's weight center on his hands is a potentially useful feature; and while this may sound logical and feasible on paper, in practice, low-set hand cranks which cause the rider to set his weight onto his hands will always be a source of trouble, creating the disadvantages I just mentioned above. I will explain why these are so in the invention summary section.

Another model using the rotary system is the U.S. Pat. No. 5,816,598 of Dodakian. Just like with the Rodriguez bicycle, the hand cranks are placed 180 degrees apart from each other (like the standard setting of regular foot pedals). Dodakian's model though has certain advantages over Rodriguez's. It can be mounted on any regular, standard bicycle frame. But the rider's weight center is again moved onto his hands, as in this model the hand cranks are located toward the cycle's front, further away from the seat. That, added on top of the lack of a friction device on the steering head, will make the Dodakian bicycle just as impossible to steer as the Rodriguez bicycle. Not to mention that adding a vertical member to the front wheel, in order to strengthen the second section of the steering coupling member, will also add extra weight and complexity to the bicycle. Another inconvenience of the Dodakian bicycle is that, just as in the Rodriguez bicycle, the handles are not located at shoulder width. This causes the rider's hands to point not only forward, but also inward (hands toward each other). Thus, the force being applied to the handles, with both of these models, will not be fully perpendicular to the cranks' handles. This results in a component of the applied force being directed inward on the cranks, reducing the effective force (the one applied perpendicular to the cranks). Also, due to this inward component of the force applied onto the hand cranks, the torque (torque=T=r×F, with r=radius of crank, F=force applied on handle) generated by the rotation of the cranks is not purely parallel to the crank axis. This torque will tend to reduce the bicycle's steering stability.

An invention designed to solve the steering problems caused by rotating handle-bars on a cycle is disclosed in the U.S. Pat. No. 5,385,359 to Ehrbar. Ehrbar places his hand cranks, again, 180 degrees apart, and then proceeds to solve the steering problems caused by the rotating hand cranks by providing a stabilizing bar including a chest saddle. The cyclist pushes on the saddle with his chest, thus controlling the left-right instability caused by operating such-designed hand cranks. So the Ehrbar bicycle is most likely easier to operate on the road than the two previously-discussed models. Its only problem though is that it requires its riders to keep pushing on the chest saddle with their chests at all times when they operate the hand cranks. The entire stabilizing bar also adds complexity to the cycle, as well as weight. Not to mention that in the case of frontal accidents such a chest saddle, placed so high and close to the rider's body, could easily harm the rider. So Ehrbar's bicycle does solve the problem of stabilizing the rotating hand cranks, but the method he employs for this scope is not the best. As it will be discussed below, in the invention summary section, the steering problems caused by rotating hand cranks can be solved to a very satisfactory and safe level in much simpler ways, by realizing that placing the rider's weight center on the bicycle's seat, combined with using steering friction mechanisms (when the hand cranks are set 180 degrees apart), remove all of the steering difficulties these previously-discussed models have.

Another bicycle using the rotary mechanism is disclosed in the U.S. Pat. No. 5,082,302 of Nacar. The Nacar bicycle uses the 0 degrees-apart position for the hand cranks, which is naturally easier to steer than the 180 degrees-apart position, as both hands move in unison and balance with more ease the steering head. The distance in between the handles is compatible with the average shoulder width, and thus the rider's hands are going to point only forward, which means that the force applied by the rider's hands is perpendicular to the hand cranks (so thus being more energy-efficient than the previous models). But this cycle still has a problem with the torque generated, as torque=T=r×F; and this time it is r, the crank radius, which is not perpendicular to the crank axis, but it is rather oblique enough to generate a significant amount of torque which is not parallel to the crank axis, and which thus reduces the bicycle's stability.

Another problem is just the way power is transmitted from the hand cranks to the foot sprockets: it involves a series of mechanisms, designed to prevent the interference in between the steering head and the front chain, when the steering head is turned to the right, but they look complicated enough to discourage potential riders from buying such a cycle.

Another bicycle that uses a rotary system as a driving mechanism for the hands is disclosed in U.S. Pat. No. 3,485,508 to Hudnall. The Hudnall bicycle is a better-designed cycle: the hand cranks are situated close to the rider, so his weight center is not onto his hands; it uses 0 degrees-placed, shoulder width-separated hand cranks, and thus it should be an easy to ride and maneuver bicycle. Its main disadvantage, though, is its complex structure, and, again, if one wishes to enjoy such a dual-powered cycle, he will need to purchase the whole bicycle, rather than simply modifying his own bicycle.

The U.S. Pat. No. 632,797 of Van Horn uses hand cranks whose settings are similar to the ones described in the previous patent, so the Van Horn bicycle is also easy to steer while turning the hand cranks. The hand cranks set do not look altogether too complex, which is another good feature this cycle has. One disadvantage with this bicycle though is that the front chain is designed to go to the regular foot sprockets, and it simply extends from the top sprocket to the foot sprockets. This means that when the steering head is turned at rather small angles to the right, probably no greater than 20 degrees, the front chain will touch the bicycle's frame. The chain will also interfere with the rider's right leg, as it extends and runs right besides it. These factors are probably the ones that determined Nacar to design the complex mechanisms he used, in order to transmit the power from the top crank to the foot sprockets, but in doing so the Nacar cycle gained too much complexity. So it appears that transmitting the power from the hand cranks to the foot sprockets has been an unsuccessful idea, and probably it is simpler to transmit the power to the front wheel, even though this will require the removal of the cycle's regular front wheel, and replacing it with a wheel containing sprockets.

One other patent belonging to this type of cycles is the U.S. Pat. No. 5,908,199, and it belongs to Rigato. The Rigato bicycle is stable, as it only uses the 0 degrees position for the separation between the right crank and the left crank. But the way the power is transmitted to the sprocket(s) on the front wheel uses a complicated mechanism involving three gears instead of one. Also, while this patent states that the brakes' cables are prevented from twisting, there is no clear mechanism shown to accomplish that purpose. As shown in FIG. 1 of Rigato's patent, the brake cables are not fully shown and thus no method to prevent twisting is present in this or the other figures.

The U.S. Pat. No. 6,099,009 of Schroeder is another example of a bicycle using a rotary mechanism for the hands. It only uses the 0 degrees position for the hand cranks, thus being stable. Its overall settings do not involve complex mechanisms, which is certainly a positive feature. Perhaps its only disadvantage is that Schroeder places his hand cranks again low and forward on the cycle, thus causing the rider to place a part of his weight center unto his hands, which is too hard on the rider's abdominal muscles to permit him to enjoy rides that are any greater than 2 or 3 miles in length.

Two more patents using the rotary system are the U.S. Pat. No. 4,773,662 and U.S. Pat. No. 6,264,224 of Phillips. Both inventions use hand cranks which are placed high on the cycle, at average shoulder width, close to the rider, and at the 0 degrees crank separation. Which makes both Phillips's models easy to ride and stable. The later model is a better-designed model than the previous one. For example, in the later model, the brakes' cables are set to point always forward, in order to not twist around the crank axis, while in the first model they were set to point to the sides, being thus potentially hazardous—as they could catch obstacles while riding. The second model of Phillips looks less complicated and safer than his first model, and it probably is the best-designed hand cranks model of all the patents I have discussed so far. But while his model must be a convenient cycle to ride, I believe my model could provide even more simplicity than his model; for example, he still uses three gears instead of one to transmit the power from the hands to the sprocket on the front wheel. He does so in order to prevent the front chain from touching the bicycle's frame, when the steering head is turned sharply to the right. I have been though riding my prototype for almost eleven years by now, and I have never had any a problem because of such a fact. At turns of 60-70 degrees to the right, yes, the chain does touch the frame, but it is practically impossible for one to still rotate the hand cranks (rotation which would cause the chain to rub against the bicycle's frame)—and, in fact, it's pretty much impossible for one to still stand on the cycle at such sharp turns. So it seems that the problem of the chain touching the frame has been overestimated, at the expense of adding unneeded parts to the cycle. Even if that were to be a concern, just sticking a small piece of scotch tape to the frame, over the spot where the chain could touch it, will prevent the chain from ever touching the frame.

So far, none of these inventions became popular, and each of them for different reasons. The bicycles using 180 degrees-positioned hand cranks, whether placed low or high on the cycle, could never be steered safely, without using some sort of a device that would hinder the steering head from turning easily. The bicycles using 0 degrees-placed hand cranks, if placed low on the cycle, were too straining on the riders' abdominal muscles. Finally, a special group in this category would be made up of the models using the 0 degrees setting, as well as an elevated level for the hand cranks. Such models are easy to steer and propel by hands, so their flaw does not stand into their functionality. Something else must have prevented these types of bicycles from making it to the market, and I believe this is their design complexity. It is thus a purpose of the proposed Panther model to provide a hand-propelled cranks assembly which is simple, light-weight, and which uses as few parts as possible, while maintaining safety and maneuverability.

An advantage the Panther cycle also has is that its prototype was extensively used: for years in a row, I rode it to school on a daily basis. My initial theoretical ideas about how to put the bicycle together were proven mostly wrong, and it is only the long practice in riding my prototype that has helped me design a more functional bicycle. So the features present in this patent are derived from experience, and I would expect them to be more successful than any features which have not been tested experimentally sufficiently long enough. After building it, I was in fact surprised at its ease of operation, and I still think something so stable and easy to ride should have made it to the market a long time ago.

Lack of finances prevented me, though, from patenting it earlier, or from building a model. And, while the prototype I built is indeed very easy to ride and stable, due to a lack of proper tools and materials, it is roughly built, and it lacks most of the features a Panther model should have—and this may have made it look rather unsafe and unappealing to most test-riders or walkers-by. However, many of the younger test-riders showed great enthusiasm toward it, and in fact it is their attitude which pushed me forward, into trying to patent this model.

### SUMMARY OF THE INVENTION

The principal objective of this invention is to provide a foot and hand driven bicycle that will be accessible to any bicycle owner by simply replacing the bicycle's seat, front wheel, and handlebar with a manually driven kit that is easy to install. Rider body size or preferences are taken into account via positioning adjustments of the installed mechanism.

It is another object of the invention to provide a foot and hand driven bicycle with an easy to modify or adjust manually driven mechanism. The invention is designed to increase the speed of a bicycle, by replacing the seat, the front wheel, and the steering head of a common bicycle with a re-designed seat, a sprocket-containing front wheel, and a rotary manually driven mechanism.

The “Panther” bicycle is propelled by the normal use of foot pedals to drive the rear wheel, and by a hand-operated crank system, which replaces the conventional front handlebar, driving the front wheel via a set of sprockets and a chain drive. Options are provided for the cyclist to adjust the front cranks mechanism in any combination of the following ways:
to position the crank pedals 180 degrees apart (as in the normal foot crank system), or at 0 degrees apart (pedals in unison). The selected cranking option would depend upon the skill and the preferences of the cyclist in hand-cranking while steering the bicycle,
to adjust the vertical position of the hand cranks system,
to adjust the horizontal position of the front cranks in order to fit the body size of the cyclist,
to adjust the cranking radius of the front cranks.

The intended use of the “Panther” bicycle is either for racing, or for more intensive recreational exercise, in which the muscles of the upper torso and arms are engaged to the maximum. The prototype “Panther” (fabricated from two 18-speed, derailleur bicycles) achieved road speeds of 33-35 mph with no previous practice in controlling the hand-cranks. Even when riding the cycle at the top speeds a rider can reach, I never noticed any left-right steering torque phenomena. Propelling it by hands alone achieves (with me) speeds of up to 8 mph when I am seated, or of up to 14 mph if I stand up. From numerous tries of riding the bicycle at maximum speeds using feet alone versus using both feet and hands, it became obvious that, in the long range, the improvement in speed over feet-only propulsion is of about 4-6 mph. This can be explained easily: besides increased wind resistance with speed, the next important issue is that, when using hands alone, the cyclist uses his stomach muscles to push forward (thus adding more power to the hand cranks), but those are the very same muscles used when the rider uses his legs as well, so the real addition to the rider's speed coming out of his arms alone adds up to only 4-6 mph, after correcting for the increased wind resistance.

To enhance steering capability, an adjustable friction device is incorporated in the steering head assembly, which has the effect of rendering the steering head resistant to momentary left-right torque variations due to the hand-cranking activity. This device proved to be indispensable when the crank pedals are set 180 degrees apart, and when tightening it up to a certain degree adds more control in steering the bicycle. However, for the case when the hand cranks are set 0 degrees apart, the friction device needs to be loosened completely.

Raising or lowering the cranks system has proved to be a very, most important issue in the steering of my existent prototype. In the first embodiment of the “Panther” cycle, the crank pedals were mounted at the normal handlebar height (like in the Rodriguez bicycle), but this configuration made steering impossible when the crank pedals were set 180 degrees apart. After adding a friction device to the steering head, steering was greatly improved, but activating the cranks kept the rider's stomach muscles tense at all times, and just a 2-3 miles ride proved to be too straining a ride. With the pedals set at 0 degrees, steering was much easier, but pedaling was still extremely hard on the rider's abdominal muscles, as the rider's upper body constantly moved up-and-down, with his hands. The idea seemed impractical, and I was at that point going to abandon the idea of the hand cranks altogether. However, before doing so, I decided to try raising the crank pedals, and see if that would make the steering any better. The results were dramatic: riding the bicycle no longer strained the rider's abdominal muscles, while steering was normal. I realized then that, by raising the hand cranks, the rider's weight center is moved backwards, from his hands unto the seat, thus obviating the need for the rider to consciously adjust his weight center, while turning the crank pedals. So it is extremely important that the rider should have his weight center stabilized onto the seat, and then he will be able to maneuver the steering head however he wishes, as his weight center doesn't move anymore, altogether with his hands.

The hand cranks can be shifted vertically in the traditional manner, by using a long bolt, which runs inside the stem sustaining the hand cranks, and which screws into a special shaped nut; tightening the bolt clamps the stem into place.

The hand cranks can be shifted horizontally by rotating them by the means of an adjustment wheel, mounted on the lower support pipe.

The driving sprocket and the driven sprockets are interconnected by an endless chain, which extends besides the front wheel. The driven sprockets can be mounted on a cassette, as with all regular bicycles' driven sprockets. Such a cassette could have multiple sprockets mounted thereon. Ever since 1996, on my present prototype the teeth number difference in between the driving sprocket and the driven sprockets has been kept at a ratio of 40/14, or 2.86. If one uses regular bicycle cassettes, whose smallest driven sprocket has 11 teeth, then the next-sized sprocket, having 12 or 13 teeth, would correspond to the 14-toothed sprocket on the Panther prototype. That could reduce the driving sprocket to a 34 or 37-toothed gear—still a rather large-sized gear. Using custom-made sprocket cassettes, though, will enable reducing the size of the driving sprocket. For example, if the smallest driven sprocket (used only for downhill riding) would have 5 teeth, that would make the driving gear a 6*2.86=17-toothed sprocket, with a diameter smaller than 3 inches—a rather small-sized gear. Such small driving sprocket looks both better and safer on the hand cranks than if we were to employ the bigger, 34 or 37-teeth driving sprockets. Alternatively, one could employ a #25 or #25h chain to drive the front wheel: this chain's pitch (0.25″) is half the size of the regular bicycle chain's pitch (0.5″). Thus, a #25 chain would allow us to employ driving and driven sprockets (including the sprockets cassettes) that are much smaller in size than the sprockets used on regular bicycles.

Mounting custom, small-sized driven cassettes on regular bicycle hubs is easily possible, on the older-style hubs, called freewheel hubs; the modern-style hubs, called freehubs, may not work with such small cassettes. Alternatively, one may employ custom-made hubs altogether. Using custom-made hubs may have its advantages, as regular freewheel hubs cannot be mounted on regular front forks, but rather one needs to replace the cycle's regular front fork with a redesigned front fork—technically, a fork identical with a normal front fork, only about 1-1.5″ wider—in order to sustain such hub. One can also widen the cycle's front fork by 1-1.5″, but this requires cutting & welding, or at least heat-bending. However, employing a custom hub will enable us to keep the original cycle's front fork. So one will have to choose the best-priced option in between using regular vs. custom-made front forks and/or hubs.

In regular cycles, only half of the driven sprockets' teeth make contact with the chain at any given time. On the Panther cycle, though, when using those custom, small-sized driven sprockets on the front wheel, one may mount (optionally) the front derailleur in a position that will force the front chain to stay more along/around the driven sprockets, covering more than just half of the sprockets' circumference—as long as this does not make gear shifting too difficult. This will enable more than just half of the driven sprockets' teeth to make contact with the chain: thus, the force exerted both on the individual driven sprockets teeth and chain links will be decreased, reducing the wear out of the driven sprockets and of the chain. The driven derailleur on the front wheel also shifts gears and maintains a constant tension in the chain, while at the same time allowing for the hand cranks to be adjusted vertically and horizontally.

When the front wheel is turned to the right at angles of 60-70 degrees, the chain touches the frame. In this particular situation hand cranking should cease (in fact such sharp turns one could only take while keeping at least one foot on the ground, thus being off the bike, so it is hard to imagine a rider in such a situation would still need to rotate the hand cranks), and then the front wheel can then be turned all the way until the turning angle is 180 degrees, if desired; this is easily made possible, due to the chain's bending flexibility, along with the front wheel derailleur's tension adjustment flexibility.

The seat is mounted on a standard bicycle seat support, and like with all modern standard seats it can shift both horizontally and vertically. However, a modification is introduced for the seat, in the form of a back support. Such seat feature is intended to provide the rider with back support, in order to counteract the rearward horizontal forces generated by the activity of pedaling with both hands and feet. The need for such a support arises from the extensive use of the Panther prototype, rather than being the result of abstract reasoning. In normal bicycles, the rider applies a force on the pedals both forward and downward. His forward pushing is counteracted by his hands, which in fact need to pull a bit backwards on the handlebar. But on the Panther bicycle, the rider pushes horizontally (forward) and vertically (downward) with both his feet and his hands, so he needs the support to counteract the horizontal push.

However, since I do not have the means to build and test such a back support, I cannot predict its precise shape and size. Only further tests may show how comfortable it feels, how much extra weight it adds to the cycle, and also how safe it will be in case of accidents. Thus, while theoretically it may be a necessary feature, only practical testing could show how reasonable it would be to introduce such a feature.

Taller riders need to shift the hand cranks toward the front of the cycle. Shifting the cranks forward, beyond a certain point, will cause the front chain to rub against the front fork's right-sided pipe. To prevent this, a small guiding cog (not shown), mounted on a short horizontal extension, may be attached to the pipe, whose role will be to push the chain away, preventing it from touching the pipe.

The driving sprocket has a guard. The guard is integral with the crank bearing housing. One may use a single driving sprocket, or one may employ a set of two or more driving sprockets. Employing a driving sprockets set, though, may require the rider to shift speeds on the driving sprockets set manually, as the addition of a driving derailleur will add too much complexity to the hand cranks system. The brakes are on the bicycle's handles, just like with any conventional bicycle. The speed changers (not shown) can be mounted on the conventional bicycle frame, either on the upper horizontal member which extends from the seat to the steering head, or unto the head tube. The angle the hand cranks make with the drive shaft on the Panther bicycle (as well as the one on the Panther prototype) is not exactly 90 degrees, but it is of around 80-82 degrees.

It may sound reasonable to think that a small deviation from a perfect 90 degrees angle will induce a non-zero torque onto the steering head, when rotating the cranks—and it probably is true. But, once again, this happens only in theory; in practice, things seem to work a bit differently. It simply feels more comfortable, and the rider gets a better control of the steering head at this particular angle range. Initially, I tried using an angle of 90 degrees, which felt worse, while an angle of 97-99 degrees felt totally awkward. This may all be due to the way human hand is designed: a person feels more comfortable with pointing his palms inward (palms facing each other) rather than outward when he stretches his hands forward, at waist level; on the other hand, when he stretches his hands forward, at shoulders level and above, it feels somewhat easier to point the palms outward rather than inward, and the slight bending of the hand cranks may be taking advantage of this fact about the human hands.

However, from the information discussed above, one should not get the misleading idea that the rider's hands themselves (so not his palms) point inward, toward each other. The bicycle's handles are by default situated at shoulder width, and thus the rider's hands point at all times straight forward. The 80-82 degrees angle affects only the way the handles—and thus the rider's palms—point, and not the way his hands themselves point. The fact is, at many times I activate the hand cranks with one hand only, and I detect no left-right torque present to upset the balance of the cycle whatsoever. Since my hand points straight forward at all times, the left-right torque is absent enough to allow me to use only one hand for cranking, while I use the other hand for holding an umbrella. And it feels natural and safe, as I am a rather cautious person, and I wouldn't be doing this otherwise.

The hand cranks set exceeds to a great measure my initial expectations; before assembling it I did not suspect that in fact it could be this easy to maneuver.

When the rider holds the pedal handles from the sides, thereby activating different torso muscles, he has to attach two rubber handles, one on each handle, which may be removed when not in use. This idea arises again from the extended use of the Panther prototype, as when the rider's hands get tired, after a while of normal activation of the hand cranks, he can grab the cranks from the sides and still pedal for another while, which suggests that this probably activates muscles not used during the normal cranking operating position/setting.

However, the elevated level of the hand cranks does not present only advantages. While the elevated level does play the crucially important role of taking the rider's weight center off of his hands, thus giving him stability on the bicycle, it also causes the rider to not be able to bend very low on the cycle, like on the racing bicycles, which will increase the rider's wind resistance. While on short distances, a Panther bicycle will be faster than any other regular bicycle, on long races, when wind resistance is very important, this may be a source of trouble. A solution to this may come in the form of a chest support plate, made of a soft material, and sustained by an elastic cord. The role of such a chest support will be to transfer the rider's weight center backwards, unto the seat, away from his hands, which should allow him to place the hand cranks low on the cycle. The cord runs around the back side of the seat's base, then along the rider's back, and then going around the rider's chest, somewhat similar with how regular backpacks are worn. As the rider leans forward and low on the cycle, the cord gets stretched, pulling the rider backwards. The elastic cord also needs to incorporate a device having an adjustable maximum tension, which can be chosen and set by the rider (as each rider's weight is different); thus, at an accident, if the tension in the cord is above the set limit, the device will open the cord, thus instantly freeing the rider from the cord and the chest plate altogether. This would be done so that, in an accident, the rider shouldn't be involuntarily tied to the cycle. However, if the proposed chest support interferes either with breathing or arms motion, then it cannot be used, and due to this fact, the Panther bicycle may not be suited for long distance races.

Also, not all the features introduced so far are absolutely necessary. Simplicity is one of the main goals of the Panther cycle—especially if this model were ever mass-produced. For example, one can choose to use only the 0 degrees position for the hand cranks, by simply making the left crank integral with the drive shaft. That would eliminate the need for a friction device as well. Also, one can choose not to vary the hand cranks' length, by using a single tube (instead of two) for each crank. Of course, by doing any of these, one will have to trade optional settings for simplicity, but I am considering it because, as a rule of thumb, the simpler a model is, the greater its chances are to make it into the market.

One other simple application of the Panther bicycle could be in the fitness industry, where one would enable the already-existing exercise upper-and-lower body gym cycles to switch their hand cranks' position from the present-only setting of 180 degrees to the one of 0 degrees and forth, depending on the users' preference. In this case, only the presented method of shifting one of the hand cranks 180 degrees unto the cranks' driving shaft will need to be employed.

The Panther prototype was built in June 1996, and it has created a lot of interest—just riding it around captivates the attention of all passers-by. Its steering properties have shown a surprising ease of operation, and so far more than 120 people have tested it successfully.

### BRIEF DESCRIPTION OF THE DRAWINGS

FIG. 1 is a side view of the bicycle.

FIG. 2 is a perspective view of the front portion of the bicycle.

FIG. 3 is a front view of the bicycle.

FIG. 4 is a view of the left crank and of the crank bearing housing.

FIGS. 5a and b is composed of two views of the friction device.

FIGS. 6a and b is composed of two views of the adjustment wheel.

FIGS. 7a and b presents various settings of the steering head.

FIG. 8 shows the left side of the elastic cord, along with the two (optional) stabilizing wheels.

### DETAILED DESCRIPTION OF THE INVENTION

The Panther bicycle uses the frame of a common bicycle 1. The regular front wheel of a bicycle is replaced by a sprockets-containing wheel 4. The cycle's front fork 5 is either a normal front fork or a redesigned front fork, as discussed above, and it sustains the wheel 4. The wheel 4 includes the driven sprockets 2, which are custom-made to be small-sized, as discussed above. The front chain 6 connects the driving sprocket(s) 31 and the driven sprockets 2, and it can be a regular bicycle chain or a #25 or #25h chain, as discussed above. The rider can shift speeds on the driven sprockets 2 with the derailleur 3, which can be mounted as to force the front chain 6 to cover more that half of the driven sprockets' 2 circumferences, as discussed above.

For simplicity, when I refer to “steering head” I refer to the all the mechanisms installed unto the front fork 5, starting with the lower support pipe 12. We can also refer to “hand cranks” as being all the mechanisms installed unto the hand cranks' bearing housing 23 (including the bearing housing 23).

The lower support pipe 12 is securely attached to the steerer, which is the upper part of the front fork 5 that runs inside the head tube (which is part of the regular frame 1). As seen in FIG. 5, the lower tubular brace 7 is tightly secured to the frame 1. A connecting metallic rod 8 is welded to the upper side of brace 7 and to the lower side of the upper tubular brace 9. The upper tubular brace 9 encloses the lower support pipe 12 and it can be tightened to the lower support pipe 12 by means of a screw 11 having two nuts 10. Tightening the screw 11 tightens the upper tubular brace 9 which in turn generates a friction force in between tubular brace 9 and lower support pipe 12 and hinders the steering head from turning easily.

The crank bearing housing 23 is attached to the adjustment wheel 16 by the means of a stem, made up of two pipes 20 and 21, running one inside the other. The long bolt 22 runs inside the stem's pipes 20 and 21 and screws into a nut that locks the two upper support pipes 20 and 21 together when tightened. This feature allows the height of the hand cranks assembly to be adjusted (identical to a standard bicycle).

The tube 20 of the stem is welded to the adjustment wheel 16, which is a solid steel cylinder that can rotate and which thus adjusts the horizontal position of the hand cranks.

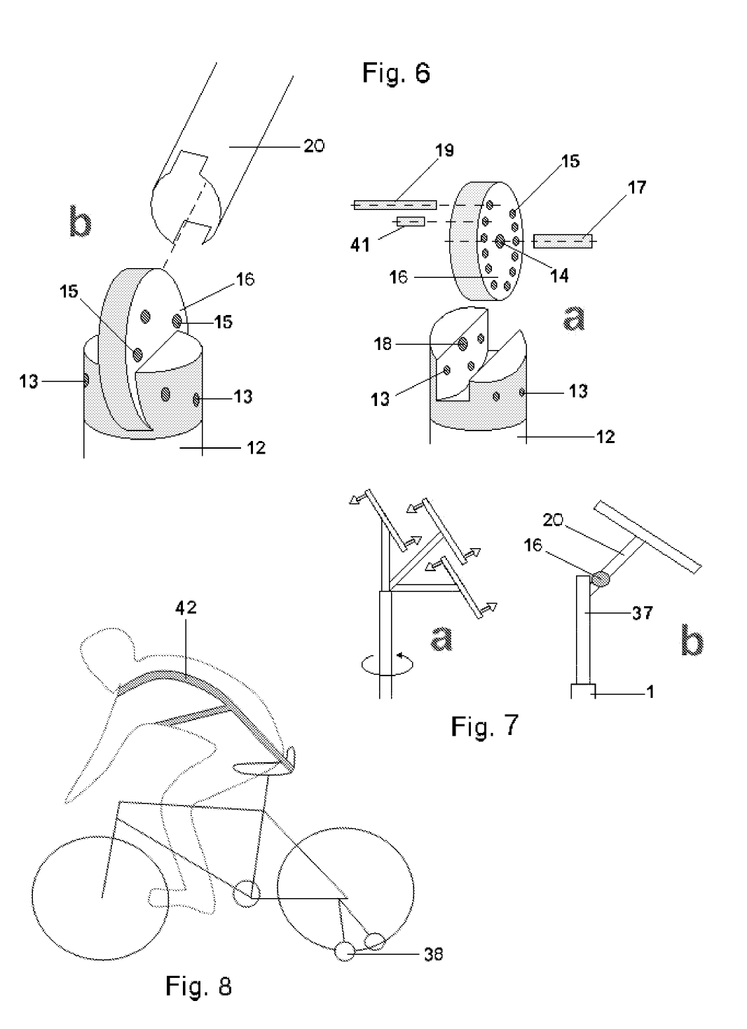

The top side of the lower support pipe 12 is made of full metal, as shown in FIG. 6, and it encloses the cylinder 16. The adjustment wheel 16 has a hole at its center 14 and the pin 17 runs through an opening 18 into the top side of the lower support pipe 12, and through the hole 14 of the cylinder 16. The pin 17 can be welded into the opening 18, on the top side of the lower support pipe 12, thus keeping the adjustment wheel 16 into place. The solid steel cylinder 16 has multiple holes 15 which can be aligned with the three holes 13 into the top of the lower support pipe 12, and three pins 19 run through the holes 13 and 15, locking the wheel 16 into place. Each pin 19 fits tightly into the holes 13 and 15, and one of its ends is Phillips headed in order to facilitate its removal by the means of a Phillips screwdriver and a small hammer, while its opposite end is flat, thus making it easy for the rider to hammer it at its flat end and put it back into place. All the holes 15 made into the adjustment wheel 16 which are not filled by the locking pins 19, are filled with short steel pins 41. The pins 41 fit in tight, and also have a Phillips-headed end and a flat end, thus being inserted or removed just like pins 19. The short pins 41 have the role of filling the cylinder 16, thus adding strength to the adjustment wheel 16.

The sprocket covering 24 is made up of a light plastic material and it is attached to the crank bearing house 23 and protects the rider from the driving sprocket(s) 31. The chain 6 is driven by the driving sprocket(s) 31. I chose here to mount the hands-propelled driving mechanisms to the right side of the cycle (as with all regular bicycles); they could be though mounted to its left side as well: by symmetry, it makes no difference whether these mechanisms are mounted on either side. The right hand crank 29 and the left hand crank 28 are adjustable in length by means of sleeved tubes, one inside the other, with holes 30 and at least one pin (not shown) on each hand crank, to lock them together. The holes in each crank which are not occupied by the pin(s) are filled by plastic caps (not shown), which can be snapped into place or popped out when the rider wants to adjust the cranks' length, in order to prevent rusting inside the pipes.

The angle each of the hand cranks makes with the drive shaft is of about 80-82 degrees, and thus in the 0 degrees-apart setting, as well as in the 180 degrees-apart position, both cranks are pointing slightly inward.

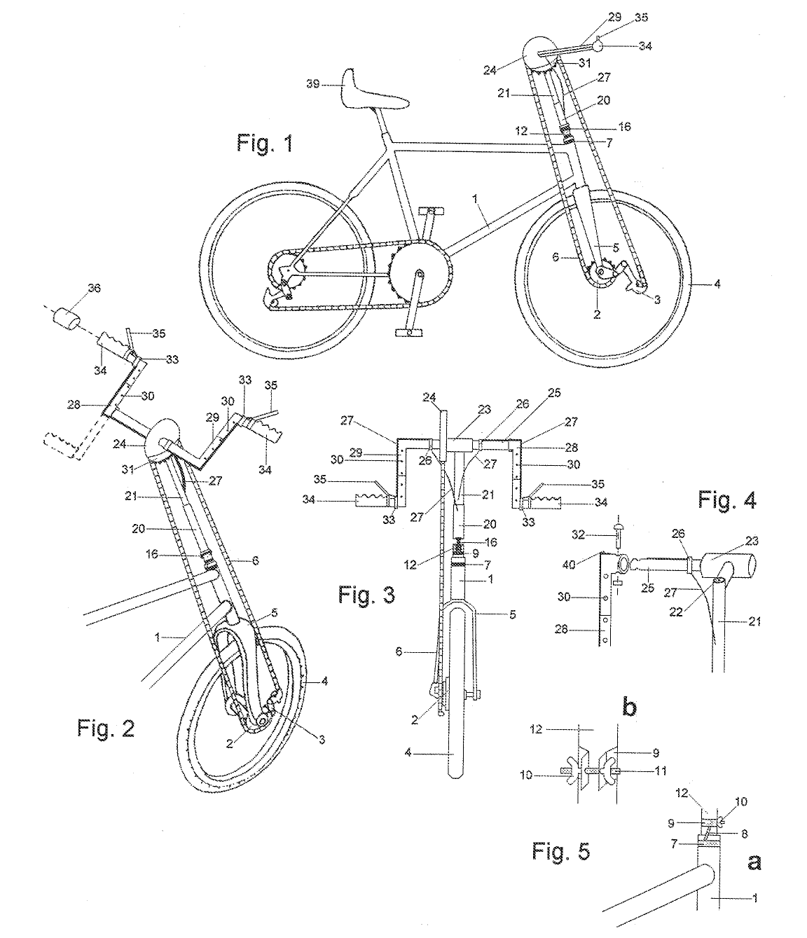

The right crank 29 is welded to the drive shaft 25. The driving sprocket(s) 31 is/are welded to the drive shaft 25, thus transmitting the power from the hand cranks to the front chain 6. The hand cranks 28 and 29 are equidistant from the center of the fork, and are provided with handles 34 that rotate on the cranks. The distance in between the handles is approximately 16″, compatible with the average shoulder width; it can though be easily custom-made, by elongating or shortening the drive shaft, to meet the needs of riders having various upper-body sizes. The left hand crank 28 can be rotated 180 degrees by detaching it from the drive-shaft 25 and positioning it in the opposite direction, as shown in FIG. 2. The left hand crank 28 is attached to the drive-shaft 25 through a screw and a nut 32. When the rider holds the pedal handles from their sides, thereby activating different torso muscles, he has to attach two rubber handles 36, one on each handle. These may be removed when not used.

The brakes 35 are attached to the cranks' handles 34 and they rotate with the handles. Both brakes work identically, so we only need to look at the left brake, for example, as the right brake works identically. The following brake model is based on the observation that in regular bicycles, all a brake lever does is to pull the brake's cable about 1″, which in turn activates the brake shoes mounted at the wheel's rim. The brake cable 27 is actually composed of three separate interconnected cables, in order to prevent twisting. The first piece of the cable 27 is connected at one end to the break itself 35, and to the topside of a bearing 33 at the other end, mounted parallel with the handle 34 and which can slide horizontally 1″ on the crank. The second piece of the brake's cable 27 is attached at one end to the innerside of the bearing 33, and at the other end, to the innerside of another bearing, 26, placed on the drive shaft 25. The bearing 26 can also slide horizontally onto the shaft itself. The third piece of the brake cable 27 is connected to the topside of the bearing 26, and it is the actual cable that goes to the wheel and activates the brake shoes. So when the rider activates the brake's 35 lever, the brake pulls the bearing 33 toward the handle 34, which in turn pulls the second piece of the brake cable 27, which in turn pulls the bearing 26, which in turn pulls the third part of the brake cable 27.

The innerside of the left bearing 26 can rotate on the shaft itself, when pushed; this is done so that when the rider switches the left crank 28 to the 180 degrees position, the second piece of the left brake cable 27 could also rotate with the crank and re-adjust to align. The second parts of the brake cables 27 pass through a hook 40 on each crank, which ensures that the brake cables stay along the cranks, preventing their twisting. The fact that the bearings 26 can slide on the drive shaft 25 also enables shifting the length of the hand cranks 28 and 29, as thus the second piece of each brake's cable 27 doesn't need a predetermined length, in order to fit a particular length setting of the hand cranks 28 and 29. This is also due to the fact that the third pieces of the brake cables 27 (the ones activating the brake shoes) are also adjustable in length, by the same mechanism used for regular bicycles' brake cables.

The saddle 39 includes a seat back, and it is vertically and horizontally adjustable, as with any conventional bicycle saddle.

For extra cautious riders, a pair of removable stabilizing wheels 38 may be attached to the cycle, for a faster learning in riding the cycle (identically with children's bicycles). These wheels 38 can be folded to the horizontal position (thus being off the ground) when not in use, or may be removed completely. Of course, there is nothing new about this feature: it only exists to help beginners feel more confidence when first-trying the Panther cycle.

For the above-discussed case, when the hand cranks are placed both forward and low on the cycle, thus enabling the rider to bend very low on the cycle, a chest support, in the form of a chest plate (not shown) sustained by an elastic cord 42 may be employed. The elastic cord runs around the seat's base, and then around the rider's back and chest, somewhat similar with how backpacks/parachutes are worn. The cord 42 also includes an adjustable maximum-tension device (not shown), which opens the cord (freeing the rider from the cord and the plate) manually, when the rider chooses to open the cord, or automatically, when the tension in the cord reaches a certain rider-set maximum level.

In FIG. 7a we observe a low-positioned hand cranks set which in fact may not affect negatively the maneuverability of the cycle. In a perfectly vertical positioning of the steering head, all the right-left rotation a rider gives to the steering head is transferred to the front wheel. But the more oblique the steering head is positioned, the less of the right-left rotation is transferred to the wheel. Thus, in a completely horizontal positioning of the steering head, rotating the handlebars influences only very little the front wheel, as most of the turning is done around the head itself. Of course, this last case is true only if the stem sustaining the hand cranks is long; the shorter the stem will be, the more influence the handlebars' rotation will have upon the front wheel. Such horizontal setting might end up being a choice for the case when the cranks are placed low and forward on the cycle (and when the rider has to use the chest plate): this setting may be more stable, thus eliminating the necessity of a friction device for the steering head, when the cranks are set 180 degrees apart.

The steering head's setting shown in FIG. 1 through FIG. 5, is the one seen easiest in FIG. 2. Here we see that the adjustment wheel 16, shifting the hand cranks horizontally, is mounted on top of the lower support pipe 12, which is very short, while the stem's pipes 20 and 21 are mounted on the adjustment wheel 16 and they shift the hand cranks vertically by the means of a long bolt 22 and a tapered nut, as discussed above. However, another option for mounting the steering head would be the setting of FIG. 7b, where a long pipe 37 is secured to the steerer. A long bolt with a nut (not seen in FIG. 7b) is mounted on top of pipe 37 and it allows the hand cranks to be shifted vertically, as in regular bicycles. This time, the support pipes 20 and 21 are replaced by a single pipe 20, mounted on top of the adjustment wheel 16. In this case, the horizontal shifting of the hand cranks will have a more limited range than the one presented in FIG. 1 through FIG. 5, but if such a setting would prove to be a more practical one, then the setting of FIG. 7b might replace the setting of FIG. 1 through FIG. 5. The option of FIG. 7b exists due to the observation that on my present prototype, designed for medium body height riders, the hand cranks are not shifted horizontally: a long stem, sustaining the hand cranks, runs inside the steerer (and, of course, the head tube), thus making no angle whatsoever with the head tube, just like the settings seen in FIG. 1 and FIG. 2 of the drawings. This could suggests that the really-needed horizontal shift may not have to be any greater than 5-6 inches, forward or backward—even after taking into account all possible various body sizes of bicycle riders. So in the case presented in FIG. 7b, pipe 20, which now is the one shifting the hand cranks horizontally, may be as short as 6 inches or less, if that would be a more practical setting.

As seen in FIG. 7b, the adjustment wheel 16 is mounted on pipe 37 on a short oblique extension, similarly with how the bearing housing 23 is mounted on the upper support pipe 21 in FIG. 4 (this is also the setting used for the Panther prototype). Also, since no bolt runs inside pipe 20 in FIG. 7b, the bearing housing (not shown in FIG. 7b) for such setting would be mounted right on top of pipe 20.

These two settings are available, and only further tests could show which setting, i.e., the one of FIG. 1 through FIG. 5, vs. the one of FIG. 7b, would work better and feel more comfortable, for riders having various body sizes.

Not being a bike specialist—by any means—may have caused me to design the rather complex way of shifting the hand cranks horizontally, by using an adjustment wheel 16. In fact, as I'm finding out, an already-existing system of shifting horizontally the handlebars through rotary motion is the one employed by the adjustable quill stem mechanism (AQSM). However, in the Panther cycle disclosed herein, the rider exerts much greater force on the hand cranks than regular cycle riders exert onto their handlebars, and thus one will have to choose in between employing a specially-designed AQSM, or an adjustment wheel mechanism 16, in terms of strength and resistance to stress versus long-term use.

In fact, for the forward-and-low-set cranks setting, such rotary motion system may not be required. One could just use a pipe including a long bolt and a nut for vertical shifting; then, at the top of the pipe, one can mount another two horizontal pipes, which through the same method of a bolt and a nut, shift the cranks horizontally. Also, such low-positioned cranks may make a seat back unnecessary, thus obviating the need for replacing the cycle's original seat.

I claim:

1) A dual drive bicycle comprising:
a frame with a rear wheel having a leg-driven propulsion system that drives the rear wheel rotatably mounted on the frame;
a fork with a front wheel mounted on an axle at the lower end of said fork and a steering head assembly installed above the fork;
wherein the steering head assembly includes a front drive hand-propulsion system with a drive shaft rotatable within a crank bearing housing and at least a front wheel drive sprocket with teeth;
a right hand crank and a left hand crank mounted on said drive shaft, with a handle mounted on each crank, and an endless chain that interconnects said front wheel drive sprocket with teeth to at least a front wheel driven sprocket with teeth for transmitting power from said hand cranks to said front wheel;
means for raising and lowering said hand cranks vertically;
means for adjusting the horizontal position of said hand cranks through rotary motion around a pivoting point.

2) A dual drive bicycle as defined in claim 1, wherein said hand cranks are positioned such that a rider's weight is taken off of his hands and stabilized onto the cycle's seat.

3) A dual drive bicycle as defined in claim 1, wherein said hand cranks are equidistant from a center of said fork.

4) A dual drive bicycle as defined in claim 3, wherein said hand cranks' handles are situated at a position compatible with the rider's shoulder width.

5) A dual drive bicycle as defined in claim 4, further including means for adjusting the length of said hand cranks.

6) A dual drive bicycle as defined in claim 5, wherein said right hand crank and said left hand crank are adjustable in length by the means of sleeved tubes, one inside the other, further including locking means which can lock said sleeved tubes together, thereby adjusting the lengths of said cranks.

7) A dual drive bicycle as defined in claim 4, wherein each of said hand cranks defines an angle of less than 90 degrees with said drive shaft, for better comfort and control.

8) A dual drive bicycle as defined in claim 7, wherein each of said hand cranks defines an angle of about 80 to 82 degrees with said drive shaft.

9) A dual drive bicycle as defined in claim 4, wherein said hand cranks are placed 0 degrees apart.

10) A dual drive bicycle as defined in claim 4, wherein said hand cranks are placed 180 degrees apart.

11) A dual drive bicycle as defined in claim 1, wherein at least one of said hand cranks is removably mounted onto said drive shaft, whereby rotating said crank with respect to said drive shaft allows repositioning said hand cranks from 0 to 180 degrees apart.

12) A dual drive bicycle as defined in claim 4, further including a drive sprocket guard attached to said crank bearing housing, whose role is to protect a rider from said driving sprocket.

13) A dual drive bicycle as defined in claim 1, wherein a lower support pipe is attached to said fork, further including an adjustment cylinder which supports said steering head assembly and which is rotatably mounted on top of said lower support pipe, thereby adjusting the horizontal position of said steering head assembly.

14) A dual drive bicycle as defined in claim 13, wherein a stem comprising an upper and a lower connecting pipes placed one inside the other, is attached at its base to said adjustment cylinder, and which enables said hand cranks assembly to be vertically adjusted by the means of a long bolt and a nut that lock said connecting pipes together when tightened.

15) A dual drive bicycle as defined in claim 13, further including a tubular brace which is securely attached to the cycle's frame, which encloses said lower support pipe and which can be tightened to said lower support pipe by tightening means, wherein tightening said tubular brace generates friction in between said tubular brace and said lower support pipe, thereby hindering said steering head from turning easily, whereby canceling any left-right steering torque generated by rotating said hand cranks.

16) A dual drive bicycle as defined in claim 1, further including a pair of brakes mounted unto said handles, wherein a set of separate pieces of brake cables running along said hand cranks and along said drive shaft, along with a set of bearings slidably mounted onto said hand cranks and unto said drive shaft, transmit the power from the brakes' levers to the brake shoes, while preventing the brakes' cables to twist when rotating said hand cranks.

17) A dual drive bicycle as defined in claim 1, further comprising a seat mounted on said bicycle's frame, said seat being provided with a back portion whose role is to counteract a rearward horizontal force generated when propelling said bicycle by pedaling with both hands and feet.

18) A dual drive bicycle including a front wheel hand cranks operated system, which can be mounted onto any bicycle frame, comprising:
(a) a steering head having with at least one sprocket mounted on a drive shaft;
(b) a pair of hand cranks which, along with a conventional set of foot pedals, propel the cycle by means of rotary motion;
(c) a continuous chain to transmit the power generated by said hand cranks to at least one sprocket mounted on the bicycle's front wheel hub;
(d) said steering head being horizontally repositioned by means of rotation around a pivot point;
(e) said steering head being vertically repositioned by vertical adjusting means.

19) The dual drive bicycle of claim 18, wherein said steering head, along with a front wheel whose shaft includes at least a driven sprocket, can be mounted and un-mounted unto any existing cycle's frame by replacing the cycle's steering head and front wheel, whereby obviating the need for custom-built bicycle frames.

20) The dual drive bicycle of claim 18, wherein a set of hand brakes are mounted on the cranks' handlebars, whose cables run along said hand cranks, rotating with said cranks by means of a set of bearings mounted unto said cranks, whereby preventing twisting of said brakes' cables when rotating said hand cranks.

21) The dual drive bicycle of claim 18, wherein a seat provided with a back support replaces the regular cycle's seat, thereby providing the rider with back support when pushing forward with both his feet and hands.

22) The dual drive bicycle of claim 18, wherein said hand cranks can be positioned 0 degrees or 180 degrees apart, corresponding to positioning said hand cranks in unison or alternatively, by means of rotating one of said hand cranks 180 degrees onto said hand cranks' drive shaft.

23) The dual drive bicycle of claim 22, wherein an adjustable friction device, comprising an adjustable tubular brace which encloses said steering head's support pipe, and which is connected by connecting means unto said cycle's frame, is employed when said cranks are positioned into said 180 degrees apart option, thus hindering said steering head from turning easily, thereby canceling momentary left-right torque variations due to hand-cranking activity when said cranks are positioned thereof.

24) The dual drive bicycle of claim 18, wherein an adjustment wheel connects said steering head's lower support pipe with said steering head's upper support pipes, and which enables horizontal shifting of said hand cranks mechanism by means of rotationary motion around a pivoting point—which is, said adjustment wheel's center.

25) The dual drive bicycle of claim 18, wherein said hand cranks' length can be varied, employing a set of sleeved tubes which slide one inside the other and that can be locked into place by locking means.

26) The dual drive bicycle of claim 18, wherein said cycle's front driving and driven gears, which transmit the power from said hand cranks to said cycle's front wheel, are custom-made to be small-sized, by using custom gears and a regular bicycle chain.

27) The dual drive bicycle of claim 18, wherein said cycle's front driving and driven gears are custom-made to be small-sized, by using a custom chain, such as a #25 or #25h chain, with its corresponding gears, thereby enabling the size reduction of said driving gear, whereby enhancing the cycle's looks and safety.

28) The dual drive bicycle of claim 18, wherein said steering head is adjustably mounted with a plurality of settings of the support pipes which support said hand cranks, and include a first setting in which the lower support pipe is short, a second setting in which said lower support pipe is replaced by two longer pipes, and the upper support pipes are replaced by a fixed-sized pipe, and a third setting for low-set cranks when no adjustment wheel is used at all.

29) The dual drive bicycle of claim 18, wherein a rider chest support including an elastic cable strapped to the back of the seat, is employed when said hand cranks are positioned low on the cycle, whose role is to take the rider's weight off of his hands, thus enabling him to bend low on the cycle, thereby reducing the wind resistance.

30) The dual drive bicycle of claim 18, wherein the angle said hand cranks make with said drive shaft is smaller than 90 degrees, 80 ±5 degrees which feels more comfortable than 90 degrees set hand cranks.

31) The dual drive bicycle of claim 18, wherein the derailleur onto said front wheel is positioned so that more than half of the driven gears' teeth come into contact with the chain at all times, thereby reducing the wear out of both the chain and gears.

32) The dual drive bicycle of claim 18, further comprising side-attached handles that can be attached to any manually-driven cranks' handles, thereby allowing the rider to grab the handles sideways, and use different muscles not used during normal hand-cranking activity.

33) A method of switching a pair of hand cranks from the 0 to the 180 degrees position and forth, corresponding to positioning the cranks in unison or alternatively, comprising:
(a) mounting at least one of said cranks in a rotational fashion unto the crank axis, and
(b) rotating said rotational crank 180 degrees and forth onto said crank axis, and
(c) providing locking means that lock said rotational crank unto said crank axis into opposite positions which lie into said hand cranks' plane.
